(19) United States
(12) Patent Application Publication
(10) Pub. No.: US 2026/0151703 A1
(43) Pub. Date: Jun. 4, 2026

(54) ELECTRONIC DEVICE AND METHOD FOR EXECUTING FUNCTION RELATED TO SLOT

(71) Applicant: NCSOFT Corporation, Seoul (KR)

(72) Inventors: Boyun KANG, Seongnam-si (KR); Kyeongdae KIM, Seongnam-si (KR); Munsu KIM, Seongnam-si (KR); Taeeun KIM, Seongnam-si (KR); Junghyun LEE, Seongnam-si (KR); Joowon LEE, Seongnam-si (KR)

(73) Assignee: NCSOFT Corporation, Seoul (KR)

(21) Appl. No.: 19/457,953

(22) Filed: Jan. 23, 2026

Related U.S. Application Data
(63) Continuation of application No. PCT/KR2023/013540, filed on Sep. 8, 2023.

(51) Int. Cl. A63F 13/533; A63F 13/537; A63F 13/69

(52) U.S. Cl. CPC A63F 13/533; A63F 13/537; A63F 13/69; A63F 2300/638

(57) ABSTRACT

There is provided an electronic device and method thereof including a display, a memory storing instructions, and at least one processor operably coupled to the display and the memory, and the at least one processor is configured, when executing the instructions, to: display, within a designated area of the display, a slot for executing a function usable for a player character (PC); on the basis of identifying a first input for the slot, display a first indicator for setting a first duration for periodic execution of the function related to the slot; and on the basis of a second input for setting the first duration for periodic execution of the function, by means of the first indicator, display a first element for indicating the first duration, superimposed on the slot.

### CROSS-REFERENCE TO RELATED APPLICATION

This application is a continuation of International Application No. PCT/KR 2023/013540, filed on Sep. 8, 2023 the disclosure of which is incorporated by reference herein in its entirety.

### BACKGROUND

### 1. Field

Various embodiments described herein relate to an electronic device and a method for executing a function related to a slot.

### 2. Description of Related Art

In a virtual space in a game application, a player character (PC) corresponding to a user of an electronic device may own items or cast a skill. The electronic device may display slots for usage of the items and/or casting of the skill. The slots may be displayed as superimposed on the virtual space. The user of the electronic device may perform usage of the items and/or casting of the skill through the PC based on an input on the slot.

The game application may provide various functions for convenience of users of the electronic device. For example, it may provide a function (e.g., an automatic hunting function) in which an operation of the PC is automatically performed without a user input to control movement of the PC.

A user of an electronic device may assign a function related to items and skills to a slot displayed on a screen for displaying a virtual space in a game. As the number of items and skills in the game increases, the user may feel uncomfortable when playing the game due to too many slots as well as limitations of the game environment itself, such as a display overload or other difficulty in displaying and/or handling too many slots. Therefore, a method for repeatedly using a function assigned to a slot for a designated duration may be required. In addition, a method for repeatedly using a plurality of functions related to a plurality of slots for the designated duration may be required.

The technical problems to be achieved in this document are not limited to those described above, and other technical problems not mentioned herein will be clearly understood by those having ordinary knowledge in the art to which the present disclosure belongs, from the following description.

### SUMMARY

There is provided electronic device including: a display; memory storing instructions; and at least one processor operably coupled to the display and the memory, wherein the at least one processor is configured to, when executing the instructions: display a slot representing a function of a player character (PC) displayed within a designated area of the display; based on identifying a first input indicating the slot, display a first indicator configured to adjustably set a first duration of a periodic execution of at least the function represented by the slot; and based on identifying a second input indicating to set the first duration of the periodic execution of at least the function through the first indicator, display a first element, representing the first duration, superimposed on the slot.

The function may include a usage function of at least one item of one or more items held by the PC, and the at least one processor may be further configured to, when executing the instructions: reduce, based on the periodic execution of at least the function represented by the slot, a number of the at least one item of the one or more items held by the PC.

The at least one processor may be further configured to, when executing the instructions: based on a duration of at least one item of one or more items represented by the slot, periodically execute at least the function represented by the slot and for the first duration.

The at least one processor may be further configured to, when executing the instructions: display, overlapping within the slot, a number of at least one item of one or more items held by the PC; and based on identifying the first input, further display the number of the at least one item of the one or more items, as identified as to be used together during the first duration, together with the first indicator.

The at least one processor may be further configured to, when executing the instructions: based on the periodic execution of at least the function, cast a skill, as performed by the PC, as the function represented by the slot.

The at least one processor may be further configured to, when executing the instructions: identify a third input indicating to set a merge slot including a plurality of slots representing a plurality of functions, wherein the plurality of slots may include the slot, and wherein the plurality of functions may include the function.

The plurality of functions may include a usage function of a plurality of items represented by the plurality of slots, and wherein periods, in which each of the plurality of functions are executed respectively, are set independently based on durations of each of the plurality of items represented by the plurality of slots.

The at least one processor may be further configured to, when executing the instructions: based on a sixth input on the merge slot, display a visual object configured to change one or more of the plurality of slots, representing the plurality of functions, included in the merge slot.

The at least one processor may be further configured to, when executing the instructions: based on the third input, identify a setting value representing a number of slots to be included in the merge slot, the number of slots being a number of the plurality of slots; and set, based on the setting value, the plurality of slots as the merge slot.

The merge slot may be configured to merge the plurality of slots to the merge slot based on the plurality of functions represented by the plurality of slots being identified as of a same type of function.

There is provided a method of an electronic device, the method including: displaying a slot representing a function of a player character (PC) displayed within a designated area of the display; based on identifying a first input indicating the slot, displaying a first indicator configured to adjustably set a first duration of a periodic execution of at least the function represented by the slot; and based on identifying a second input indicating to set the first duration of the periodic execution of at least the function related to the slot through the first indicator, displaying a first element, representing the first duration, superimposed on the slot.

The function may include a usage function of at least one item of one or more items held by the PC, and the method further may include: reducing, based on the periodic execution of at least the function represented by the slot, a number of the at least one item of the one or more items held by the PC.

The method further may include: based on a duration of at least one item of one or more items represented by the slot, periodically executing at least the function represented by the slot and for the first duration.

The method further may include: displaying, overlapping within the slot, a number of at least one item of one or more items held by the PC; and based on identifying the first input, further displaying the number of the at least one item of the one or more items, as identified as to be used together during the first duration, together with the first indicator.

The method further may include: based on the periodic execution of at least the function, casting a skill, as performed by the PC, as the function represented by the slot.

The method further may include: identifying a third input indicating to set a merge slot including a plurality of slots representing a plurality of functions, wherein the plurality of slots may include the slot; and wherein the plurality of functions may include the function; based on identifying a fourth input as indicating the merge slot, displaying a second indicator configured to set a second duration for a second periodic execution of the plurality of functions represented by the plurality of slots; and based on a fifth input indicating, through the second indicator, to set the second duration for the second periodic execution of the plurality of functions, displaying a second element, representing the second duration, superimposed on the merge slot.

The plurality of functions may include a usage function of a plurality of items represented by the plurality of slots, and wherein periods, in which each of the plurality of functions are executed respectively, are set independently based on durations of each of the plurality of items represented by the plurality of slots.

The method further may include: based on a sixth input on the merge slot, displaying a visual object configured to change one or more of the plurality of slots, representing the plurality of functions, included in the merge slot.

The method further may include: based on the third input, identifying a setting value representing a number of slots to be included in the merge slot, the number of slots being a number of the plurality of slots; and setting, based on the setting value, the plurality of slots as the merge slot.

There is provided a computer readable storage media storing one or more programs, wherein the one or more programs include instructions which, when executed by at least one processor of an electronic device with a display, cause the electronic device to: display a slot representing a function of a player character (PC) displayed within a designated area of the display; based on identifying a first input indicating the slot, display a first indicator for setting a first duration for periodic execution of a function related to the slot; and based on identifying a second input setting the first duration of the periodic execution of at least the function related to the slot through the first indicator, display a first element, representing the first duration, superimposed on the slot.

An electronic device and a method according to various embodiments can display a first indicator for setting a first duration for periodic execution of a function related to a slot. The electronic device can periodically execute the function related to the slot for the first duration through the first indicator based on an input for setting the first duration.

The effects that can be obtained from the present disclosure are not limited to those described above, and any other effects not mentioned herein will be clearly understood by those having ordinary knowledge in the art to which the present disclosure belongs, from the following description.

### BRIEF DESCRIPTION OF THE DRAWINGS

The above and other aspects, features, and advantages of specific embodiments of the present disclosure will be more apparent from the following description with reference to the accompanying drawings, in which:

FIG. 1 is a block diagram for describing an electronic device and an external electronic device connected to each other based on a network;

FIG. 2 illustrates a user interface (UI) of an exemplary game application displayed on a display of an electronic device according to one or more embodiments;

FIG. 3 illustrates a flowchart related to an operation of an electronic device according to one or more embodiments;

FIG. 4 illustrates an example of an operation of an electronic device for periodic execution of a function related to a slot according to one or more embodiments;

FIG. 5 illustrates a flowchart related to an operation of an electronic device according to one or more embodiments;

FIG. 6 illustrates an example of an operation of configuring slots included in a merge slot according to one or more embodiments;

FIG. 7 illustrates an example of an operation of an electronic device for periodic execution of a plurality of functions related to a merge slot according to one or more embodiments;

FIG. 8A illustrates an example of an operation of an electronic device for configuring a merge slot according to one or more embodiments;

FIG. 8B illustrates an example of an operation of an electronic device for configuring a merge slot according to one or more embodiments; and

FIG. 8C illustrates an example of an operation of an electronic device for configuring a merge slot according to one or more embodiments.

### DETAILED DESCRIPTION

The electronic device according to various embodiments may be one of various types of electronic devices. The electronic devices may include, for example, a portable communication device (e.g., a smartphone), a computer device, a portable multimedia device, a portable medical device, a camera, a wearable device, a server, or a home appliance. According to one or more embodiments of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with the present document, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to one or more embodiments, the module may be implemented in a form of an application-specific integrated circuit (ASIC).

Various embodiments as set forth herein may be implemented as software (e.g., the program) including one or more instructions that are stored in a storage medium that is readable by a machine (e.g., the electronic device). For example, a processor of the machine (e.g., the electronic device) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to one or more embodiments, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™ or AppStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

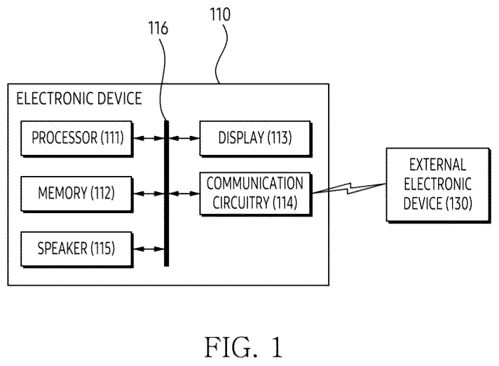

FIG. 1 is a block diagram for describing an electronic device and an external electronic device connected to each other based on a network. Referring to FIG. 1, an exemplary situation in which an electronic device 110 and an external electronic device 130 are connected to each other based on a wired network and/or a wireless network is illustrated.

The wired network may include a network such as the Internet, a local area network (LAN), a wide area network (WAN), Ethernet, or a combination thereof. The wireless network may include a network such as long-term evolution (LTE), 5G new radio (NR), wireless fidelity (WiFi), ZigBee, near field communication (NFC), Bluetooth, Bluetooth low energy (BLE), or a combination thereof. Although the electronic device 110 and the external electronic device 130 are illustrated to be directly connected, the electronic device 110 and the external electronic device 130 may be indirectly connected through one or more routers and/or an Access Point (AP).

In various embodiments, the electronic device 110 may be a terminal owned by different users. In various embodiments, the electronic device 110 may be a client device for users playing an online game. The terminal may include, for example, a personal computer such as a laptop and a desktop, a smartphone, a smartpad, a tablet personal computer, and smart accessories such as a smartwatch and a Head-Mounted Device (HMD). Users of the electronic device 110 may be subscribers of a service provided by the external electronic device 130.

In various embodiments, the external electronic device 130 may include a server of a service provider. The server may include one or more personal computers and/or workstations. In one or more embodiments, the external electronic device 130 may be at least one server that provides a service for the online game. For example, the external electronic device 130 may include a game server, a database that stores user information of the online game, and a data service that stores data for execution of the online game. For example, within the database, the data for the execution of the online game may be stored as a record and/or a table distinguished for each subscriber of the online game. For example, the record may include content (e.g., data associated with a virtual item described herein, for example) to be exclusively provided to the subscriber through the online game. Data associated with the virtual item may correspond, for example, to at least one parameter used in the execution of the game, such as an owner, a price, and a layout.

Referring to FIG. 1, the electronic device 110 according to one or more embodiments may include a processor 111, memory 112, a display 113, communication circuitry 114, and a speaker 115. The processor 111, the memory 112, the display 113, the communication circuitry 114, and the speaker 115 may be electronically and/or operably coupled with each other by an electronic component such as a communication bus 116. Although illustrated based on different blocks, one or more embodiments are not limited thereto, and a portion (e.g., at least a portion of the processor 111, the memory 112, and the communication circuitry 114) of hardware components illustrated in FIG. 1 may be included in a single integrated circuit (SIC), such as a System on a Chip (SoC). A type and/or the number of the hardware components included in the electronic device 110 is not limited as illustrated in FIG. 1. For example, the electronic device 110 may include only a portion of the hardware components illustrated in FIG. 1.

The processor 111 of the electronic device 110 according to one or more embodiments may include a hardware component for processing data based on one or more instructions. The hardware components for processing data may include, for example, an Arithmetic and Logic Unit (ALU), a Floating Point Unit (FPU), a Field Programmable Gate Array (FPGA), and/or a Central Processing Unit (CPU). The number of processors 111 may be one or more. For example, the processor 111 may have a structure of a multi-core processor 111, such as a dual core, a quad core, or a hexa core.

The memory 112 of the electronic device 110 according to one or more embodiments may include a hardware component for storing data and/or instructions inputted to and/or outputted from the processor 111. The memory 112 may include, for example, volatile memory such as random-access memory (RAM) and/or non-volatile memory such as a read-only memory (ROM). The volatile memory may include, for example, at least one of dynamic RAM (DRAM), static RAM (SRAM), cache RAM, and pseudo SRAM (PSRAM). The non-volatile memory 112 may include, for example, at least one of a Programmable ROM (PROM), an Erasable PROM (EPROM), an Electrically Erasable PROM (EEPROM), flash memory, a hard disk, a compact disk, and an embedded Multi Media Card (eMMC).

In the memory 112, one or more instructions representing an operation to be performed by the processor 111 on data may be stored. A set of instructions may be referred to as firmware, an operating system, a process, a routine, a sub-routine and/or an application. For example, the electronic device 110 and/or the processor 111 of the electronic device 110 may perform at least one of operations illustrated in the drawings described below and herein by executing a set of a plurality of instructions distributed in a form of an application. Hereinafter, an application being installed in the electronic device 110 may mean that one or more applications provided in a form of the application are stored in the memory 112 of the electronic device 110, and that the one or more applications are stored in an executable format (e.g., a file with an extension designated by an operating system of the electronic device 110) by the processor 111 of the electronic device 110.

The display 113 of the electronic device 110 according to one or more embodiments may output visualized information (e.g., at least one of UIs described below and herein) to a user. For example, the display 113 may output the visualized information to the user by being controlled by a controller such as the processor 111. The display 113 may include a Flat Panel Display (FPD) and/or electronic paper. The FPD may include a Liquid Crystal Display (LCD), a Plasma Display Panel (PDP), and/or one or more Light Emitting Diodes (LEDs). The LED may include an Organic LED (OLED).

The display 113 of the electronic device 110 according to one or more embodiments may include a sensor (e.g., a touch sensor panel (TSP)) for detecting an external object (e.g., a finger of the user) on the display 113. For example, based on the TSP, the electronic device 110 may detect the external object contacted with the display 113 or floating on the display 113. In response to detecting the external object, the electronic device 110 may execute a function related to a specific visual object corresponding to a position of the external object on the display 113 among visual objects displayed in the display 113.

The display 113 may include a panel and at least one Display Driver Integrated-Circuit (DDI). For example, in a case that the panel includes a plurality of LEDs arranged in a form of a two-dimensional matrix, the DDI may control at least one LED included in a corresponding row or column among the plurality of LEDs. The DDI controlling of the at least one LED may include an operation of adjusting luminance and/or brightness of the LEDs.

The communication circuitry 114 of the electronic device 110 according to one or more embodiments may include a hardware component for supporting transmission and/or reception of an electrical signal between the electronic device 110 and the external electronic device 130. Although only the external electronic device 130 is illustrated, one or more embodiments are not limited thereto, and for example, the electronic device 110 may communicate with other external electronic devices 130. The communication circuitry 114 may include, for example, at least one of MODEM, an antenna, and an Optic/Electronic (O/E) converter. The communication circuitry 114 may support transmission and/or reception of the electrical signal based on various types of protocols such as Ethernet, a LAN, a WAN, WiFi, BLE, ZigBee, LTE, and 5G R.

The electronic device 110 according to one or more embodiments may include an output means for outputting information in a form other than a visualized form. For example, the electronic device 110 may include the speaker 115 for outputting an acoustic signal. The number of speakers 115 included in the electronic device 110 may be one or more. The electronic device 110 may include other output means for outputting information in a form other than a visual form and an audible form. For example, the electronic device 110 may include a motor for providing haptic feedback based on physical vibration.

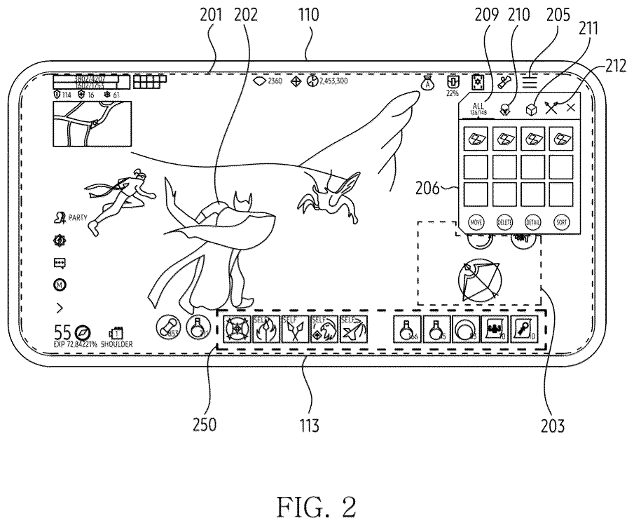

FIG. 2 illustrates a UI of an exemplary game application displayed on a display of an electronic device according to one or more embodiments.

Referring to FIG. 2, a UI 201 of the exemplary game application displayed on a display 113 of an electronic device 110 is illustrated. For example, the electronic device 110 may provide screens to a user in a state in which matching between the electronic device 110 and an external electronic device (e.g., the external electronic device 130 of FIG. 1) is performed. Hereinafter, a screen may mean a UI displayed in at least a portion of the display 113.

According to one or more embodiments, the UI 201 may include a virtual space displayed based on the game application, a PC 202 (player character) corresponding to the user of the electronic device 110, an icon 203 for controlling movement of the PC 202, and an icon 205 for selecting various settings of the game application.

According to one or more embodiments, the electronic device 110 may display a plurality of slots within an area 250 set in the UI 201. For example, the plurality of slots may be configured with a designated number. As an example, the electronic device 110 may change the number of the plurality of slots based on a setting value. For example, the plurality of slots may be used to perform a designated function. As an example, a first slot may be used to perform a first function. A second slot may be used to perform a second function.

According to one or more embodiments, a function may be assigned to each of the plurality of slots. For example, one of an item, a skill, and equipment may be disposed in one slot (hereinafter, referred to as the first slot) among the plurality of slots. When an item is disposed in the first slot, the electronic device 110 may use the item based on identifying an input on the first slot. When a skill is disposed in the first slot, the electronic device 110 may cast the skill based on identifying the input on the first slot. When equipment is disposed in the first slot, the electronic device 110 may mount the corresponding equipment to the PC 202 based on identifying the input on the first slot.

According to one or more embodiments, the electronic device 110 may display the plurality of slots in the area 250. For example, the area 250 may not be in a fixed state. According to one or more embodiments, the electronic device 110 may change a position of the area 250 based on a user input. For example, the electronic device 110 may display the area 250 on an upper end of the PC 202. For example, the electronic device 110 may display the area 250 on a left side and/or a right side based on the PC 202. According to one or more embodiments, the area 250 may be configured with one or more areas. For example, a first area included in the area 250 may be displayed on the upper end of the PC 202. A second area included in the area 250 may be displayed on a lower end of the PC 202.

According to one or more embodiments, a function may be assigned to each of the plurality of slots based on a user input. For example, the electronic device 110 may display a UI 206, superimposed on the UI 201, for indicating a list of functions that may be performed through the PC 202 based on a user input. The functions that may be performed through the PC 202 may include items owned by the PC 202, skills that the PC 202 may cast, and/or equipment owned by the PC 202. The electronic device 110 may display a list of all functions that may be performed through the PC 202 in the UI 206 based on an input on an object 209. The electronic device 110 may display a list of the equipment owned by the PC 202 in the UI 206 based on an input on an object 210. The electronic device 110 may display a list of the items owned by the PC 202 based on an input on an object 211. The electronic device 110 may display a list of the skills that the PC 202 may cast based on an input on an object 212.

For example, the electronic device 110 may assign a function to each of the plurality of slots based on an input received from the user. Basically, the plurality of slots may be set as an empty slot. In a case that a function is not assigned to a slot, the slot may be set as an empty slot. The electronic device 110 may assign some of the functions that may be performed through the PC 202 displayed on the UI 206 to the plurality of slots. The electronic device 110 may assign some of the functions that may be performed through the PC 202 displayed on the UI 206 to the plurality of slots based on a user input.

For example, the electronic device 110 may execute at least one of functions assigned to the plurality of slots based on an input on at least one of the plurality of slots.

As an example, a function for using a designated item may be assigned to the first slot among the plurality of slots. An object representing the designated item may be displayed on the first slot. The electronic device 110 may use the designated item through the PC 202 based on the input on the first slot.

As an example, a function for using a designated skill may be assigned to the second slot among the plurality of slots. An object representing the designated skill may be displayed on the second slot. The electronic device 110 may cast the designated skill through the PC 202 based on an input on the second slot.

As an example, a function for mounting designated equipment may be assigned to a third slot among the plurality of slots. An object representing the designated equipment may be displayed on the third slot. The electronic device 110 may mount the designated equipment through the PC 202 based on an input on the third slot.

The user of the electronic device 110 may repeatedly use a function related to a slot in a specific situation. For example, the user of the electronic device 110 may repeatedly use a health (or mana) recovery item owned by the PC 202 in a combat situation. In this case, since the user should perform repeatedly an input on the slot, the user may feel uncomfortable. Therefore, in the following specification, the electronic device 110 and a method for periodically executing a function related to a slot will be described. In addition, in the following specification, the electronic device 110 and a method for periodically executing a plurality of functions related to a plurality of slots will be described.

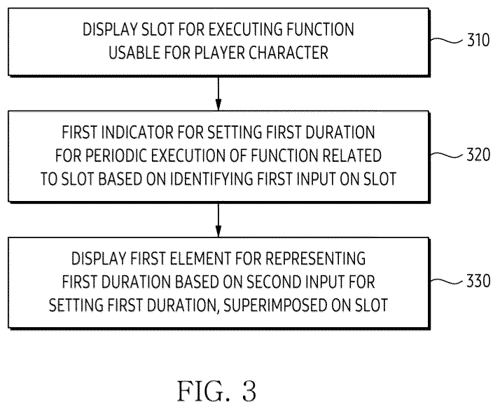

FIG. 3 illustrates a flowchart related to an operation of an electronic device according to one or more embodiments. The electronic device 101 and/or the processor 111 of FIG. 1 may perform operations described with reference to FIG. 3. In the following embodiment, each of operations may be sequentially performed, but is not necessarily performed sequentially. For example, an order of each of operations may be changed, and at least two operations may be performed in parallel.

Referring to FIG. 3, in operation 310, an electronic device 110 may display a slot for executing a function usable for a PC 202. For example, the electronic device 110 may display a plurality of slots within a designated area (e.g., the designated area 250 of FIG. 2) in a UI (e.g., the UI 201 of FIG. 2) displayed on a display 113.

According to one or more embodiments, the electronic device 110 may execute a function related to a slot based on an input on the slot. For example, the electronic device 110 may use an item based on an input on a slot. For example, the electronic device 110 may cast a skill through the PC 202 based on an input on a slot. For example, the electronic device 110 may mount equipment through the PC 202 based on an input on a slot.

For example, in a case that the function related to the slot is set as a usage function of items, the electronic device 110 may display overlappingly the number of items held by the PC 202 within the slot. In a case that the function related to the slot is set as a mount function of equipment, the electronic device 110 may display overlappingly durability of the equipment within the slot. In a case that the function related to the slot is set as a skill casting function, the electronic device 110 may display overlappingly the number of times that the skill may be cast within the slot.

In operation 320, the electronic device 110 may display a first indicator for setting a first duration for periodic execution of the function related to the slot based on identifying a first input on the slot.

According to one or more embodiments, the electronic device 110 may identify the first input on the slot. For example, the first input may include a long press input, a swipe input, a double tap input, and a double click input. For example, the first input may be distinguished from an input for executing the function related to the slot. As an example, the input for executing the function related to the slot may include a tap input and a click input.

According to one or more embodiments, the electronic device 110 may display the first indicator for setting the first duration for the periodic execution of the function related to the slot based on identifying the first input.

For example, the electronic device 110 may display the first indicator. The first indicator may be displayed based on an area expanded from the slot. As an example, a size of the first indicator may be set to increase based on the first indicator moving along a designated direction. The size of the first indicator may be set to decrease based on the first indicator moving along a direction opposite to the designated direction. The electronic device 110 may set the first duration to be longer based on the increase in the size of the first indicator. The electronic device 110 may set the first duration to be shorter based on the decrease in the size of the first indicator. For example, the electronic device 110 may display reference durations together with the first indicator. One of the reference durations may be set as the first duration through the first indicator. According to one or more embodiments, the first indicator may be overlappingly displayed on the slot.

For example, the function related to the slot may include the usage function of the items held by the PC. The electronic device 110 may display the number of items to be used for the first duration together with the first indicator based on identifying the first input. As an example, the electronic device 110 may display the number of items to be used for the first duration, superimposed on the first indicator.

In operation 330, the electronic device 110 may display a first element for representing the first duration based on a second input for setting the first duration, superimposed on the slot.

According to one or more embodiments, the electronic device 110 may identify the second input for setting the first duration. For example, the electronic device 110 may identify the second input for setting the first duration through the first indicator. The second input may include a drag input. As an example, the electronic device 110 may change the size of the first indicator based on the drag input. The electronic device 110 may identify the size of the first indicator based on release of the drag input. The electronic device 110 may set the first duration based on the size of the first indicator.

According to one or more embodiments, the electronic device 110 may display the first element for representing the first duration, superimposed on the slot. For example, the electronic device 110 may display the first element for representing the first duration at an upper left end of the slot. The first duration represented by the first element may decrease over time. For example, in a case that the function related to the slot is set as the usage function of the items held by the PC 202, the electronic device 110 may display the number of items held by the PC 202 together with the first element, superimposed on the slot. The electronic device 110 may reduce the number of items held by the PC 202 based on the periodic execution of the function. Whenever an item is used in the first duration, the electronic device 110 may display the number of items by subtracting them, superimposed on the slot.

For example, in a case that the function related to the slot is set as the usage function of the items held by the PC 202, the electronic device 110 may periodically execute the function related to the slot for the first duration based on a duration of the items. For example, the duration may be set differently according to items. As an example, a health recovery item may be set to recover health of the PC 202 for 10 seconds. The electronic device 110 may execute the function related to the slot at a period of 10 seconds. The electronic device 110 may execute the function related to the slot for the first duration at the period of 10 seconds. In a case that the first duration is set to 10 minutes, 60 health recovery items may be used for the first duration.

For example, in a case that the function related to the slot is set to the skill casting function that may be performed by the PC 202, the electronic device 110 may cast a skill that may be performed by the PC 202 based on the periodic execution of the function related to the slot. The electronic device 110 may cast the skill at a period of a cooldown time of the skill (e.g., a time set for cooldown) for the first duration.

According to one or more embodiments, the electronic device 110 may execute the function related to the slot for the first duration based on satisfying a designated condition. As an example, the electronic device 110 may execute the function related to the slot for the first duration based on identifying that the health of the PC 202 is less than or equal to a designated value. The electronic device 110 may use the health recovery item based on identifying that the health of the PC 202 is less than or equal to the designated value. Whenever identifying that the health of the PC 202 is less than or equal to the designated value for the first duration, the electronic device 110 may use the health recovery item.

According to one or more embodiments, the electronic device 110 may periodically execute the function related to the slot for the first duration without the input on the slot. The electronic device 110 may provide a notification to the user after the first duration has elapsed. For example, the electronic device 110 may change a display of the slot based on the elapse of the first duration. As an example, the electronic device 110 may display the slot to blink based on the elapse of the first duration. As an example, the electronic device 110 may provide a physical vibration based on the elapse of the first duration. As an example, the electronic device 110 may provide a notification representing that the first duration has elapsed through a visual object representing a pop-up window based on the elapse of the first duration.

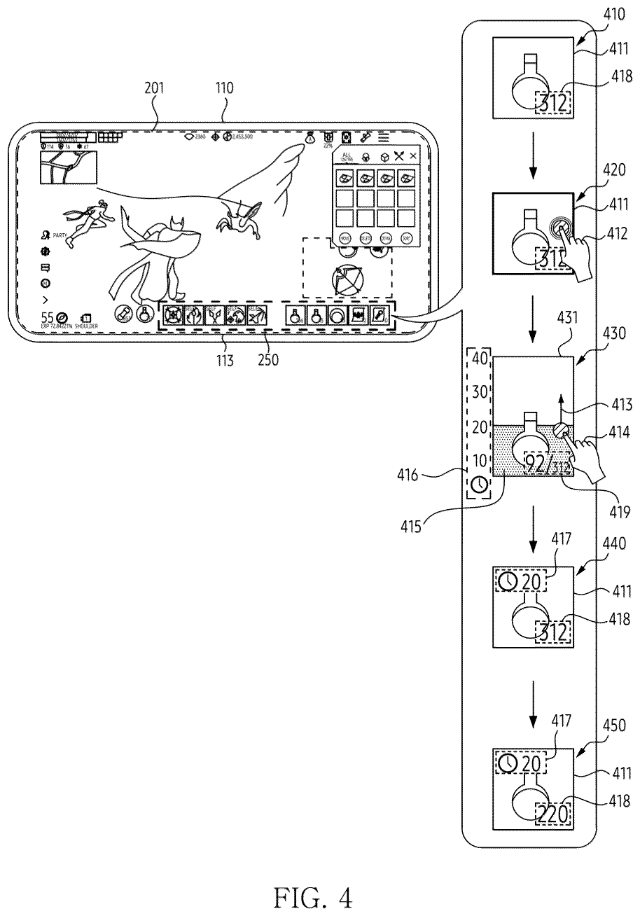

FIG. 4 illustrates an example of an operation of an electronic device for periodic execution of a function related to a slot according to one or more embodiments.

Referring to FIG. 4, an electronic device 110 may display a UI 201 of a game application through a display 113. For example, the UI 201 may include a designated area 250. The electronic device 110 may display slots within the designated area 250.

In a state 410, the electronic device 110 may display a slot 411. For example, the slot 411 may be used for execution of functions usable for a PC 202. As an example, the slot 411 may be used for a usage function of items. Hereinafter, for convenience of description, an example in which the slot 411 is used for execution of the usage function of the items is described, but is not limited thereto. According to one or more embodiments, the slot 411 may be used for casting a skill. According to one or more embodiments, the slot 411 may be used for mounting equipment.

For example, the electronic device 110 may display an element 418 representing the number of items held by the PC 202 within the slot 411. The electronic device 110 may display the element 418 representing the number of items held by the PC 202, superimposed on the slot 411.

According to one or more embodiments, the electronic device 110 may identify an input for executing a function (i.e., an item usage function) for the slot 411. The input for executing the function for the slot 411 may include a tap input and a click input. The electronic device 110 may execute a function (i.e., the item usage function) related to a slot based on the input for executing the function for the slot 411. Based on executing the function related to the slot, the electronic device 110 may change and display the element 418 representing the number of items held by the PC 202.

In a state 420, the electronic device 110 may identify a first input 412 on the slot 411. For example, the first input 412 may include a long press input, a swipe input, a double tap input, and a double click input. Long press input is an input held for a preset amount of time, such as for 1 second, 2 seconds, etc.

In a state 430, the electronic device 110 may display a first indicator 415 for setting a first duration for periodic execution of a function related to the slot 411 based on identifying the first input 412 of the state 420. For example, the electronic device 110 may display the first indicator 415 superimposed on the slot 411.

According to one or more embodiments, the electronic device 110 may expand the slot 411. The electronic device 110 may display the first indicator 415 based on the expansion of the slot 411. For example, the electronic device 110 may expand a shape of the slot 411 based on identifying the first input 412 of the state 420. For example, the electronic device 110 may set an area 431 in which the first indicator 415 is movable based on expanding the slot 411. The electronic device 110 may set the first indicator 415 to be movable within the area 431.

For example, the electronic device 110 may move the first indicator 415 along one of a direction 413 and a direction opposite to the direction 413. As the first indicator 415 is moved in the direction 413, a size of the first indicator 415 may increase. As the first indicator 415 is moved in the direction opposite to the direction 413, the size of the first indicator 415 may decrease.

For example, the electronic device 110 may display reference durations together with the first indicator. The electronic device 110 may display an element 416 for displaying the reference durations together with the slot 411. According to one or more embodiments, the element 416 may be disposed to be adjacent to the slot 411 along the direction 413.

For example, the electronic device 110 may set one of the reference durations as the first duration through the first indicator 415. As an example, the electronic device 110 may set the first duration to be shorter based on the decrease in the size of the first indicator 415. The electronic device 110 may set the first duration to be longer based on the increase in the size of the first indicator 415.

For example, the electronic device 110 may identify a second input 414 for setting the first duration. The electronic device 110 may identify the second input for moving the first indicator 415 and for releasing the movement of the first indicator 415. As an example, the second input may include a drag input. The electronic device 110 may move the first indicator 415 based on the drag input. The electronic device 110 may set one of the reference durations indicated by the first indicator 415 as the first duration based on release of the drag input.

For example, the electronic device 110 may display an element 419 representing the number of items to be used during the first duration together with the first indicator 415. As an example, the electronic device 110 may display the element 419 representing the number of items to be used during the first duration, superimposed on the first indicator 415. According to one or more embodiments, the element 419 may represent the number of items (e.g., ‘92’ of the state 430) to be used during the first duration for the number of items held by the PC 202. The electronic device 110 may represent the number of items held by the PC 202 (e.g., ‘312’ of the state 430) and the number of items to be used during the first duration through the element 419.

A state 440 may represent a state after the second input 414 is received. For convenience of description, in the state 440, the second input 414 illustrated in the state 430 may be referenced.

In the state 440, the electronic device 110 may display a first element 417 for representing the first duration, superimposed on the slot 411, based on the second input 414. For example, the electronic device 110 may identify the second input 414. The electronic device 110 may identify the first duration based on the second input 414. The electronic device 110 may display the first element 417 for representing the first duration, superimposed on the slot 411. The electronic device 110 may further display the element 418 for representing the number of items held by the PC superimposed on the slot 411.

For example, the electronic device 110 may display the first element 417 for representing the first duration on an upper left end of the slot 411. The first element 417 may decrease over time. For example, the electronic device 110 may reduce the number of items held by the PC 202 based on periodic execution of a function. Whenever an item is used within the first duration, the electronic device 110 may reduce the number of items represented through the element 418. Whenever an item is used within the first duration, the electronic device 110 may change a display of the first element 417 overlappingly displayed on the slot 411.

For example, the electronic device 110 may periodically execute the function related to the slot 411 for the first duration based on a duration of an item. The electronic device 110 may periodically execute the function related to the slot 411 for the first duration at a period of the duration of the item.

For example, the electronic device 110 may execute the function related to the slot 411 for the first duration based on satisfaction of a designated condition. Whenever identifying that the PC 202 is in a designated state in the first duration, the electronic device 110 may execute the function related to the slot 411.

In the state 450, the electronic device 110 may periodically execute the function related to the slot 411 for the first duration without an input on the slot 411. The electronic device 110 may provide a notification to a user after the first duration has elapsed. For example, the electronic device 110 may change a display of the slot 411 based on the elapse of the first duration. As an example, the electronic device 110 may display the slot 411 to blink based on the elapse of the first duration. As an example, the electronic device 110 may provide a physical vibration based on the elapse of the first duration. As an example, the electronic device 110 may provide a notification representing that the first duration has elapsed through a visual object representing a pop-up window based on the elapse of the first duration.

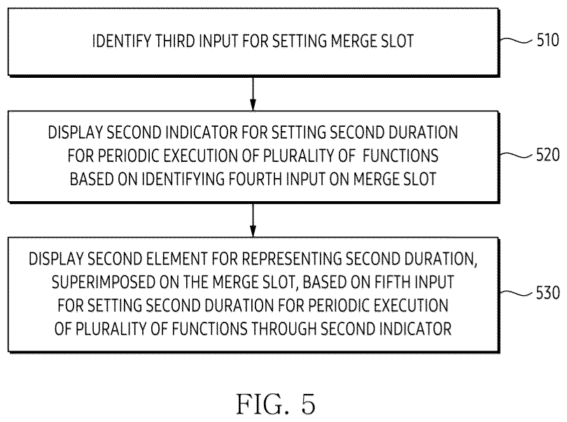

FIG. 5 illustrates a flowchart related to an operation of an electronic device according to one or more embodiments. In the following embodiment, each of operations may be sequentially performed, but is not necessarily performed sequentially. For example, an order of each of operations may be changed, and at least two operations may be performed in parallel.

Referring to FIG. 5, in operation 510, an electronic device 110 may identify a third input for setting a merge slot. For example, the electronic device 110 may set the merge slot including a plurality of slots based on the third input.

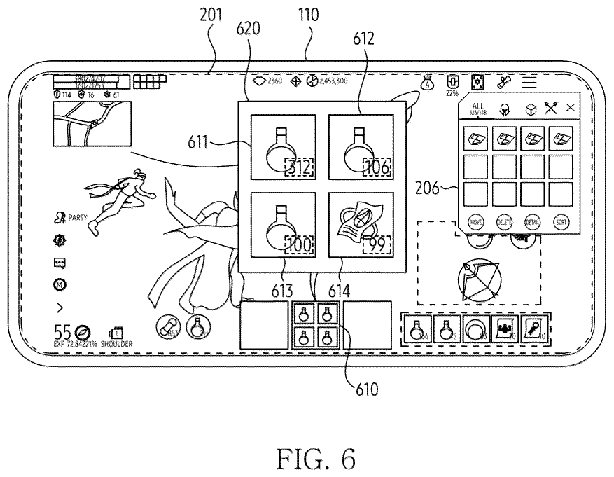

According to one or more embodiments, the electronic device 110 may identify an input for assigning a function to each of the plurality of slots (e.g., a slot and at least one slot) included in the merge slot. An example of the input for assigning the function to each of the plurality of slots included in the merge slot will be described with reference to FIG. 6. The input for assigning the function to each of the plurality of slots included in the merge slot may be an example of the third input.

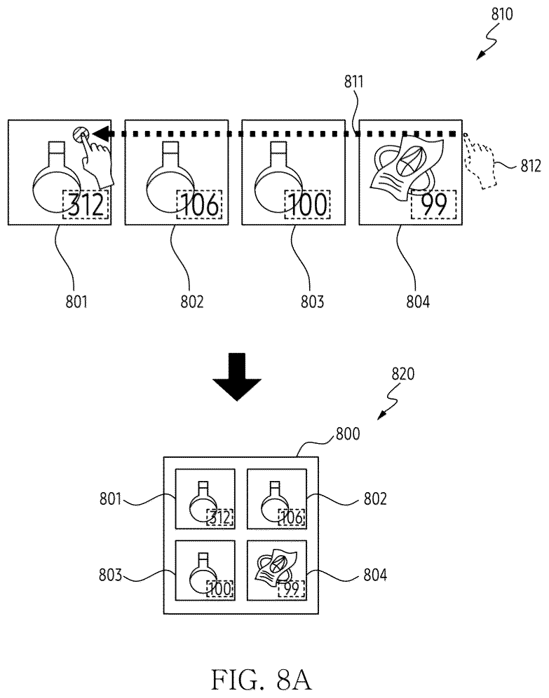

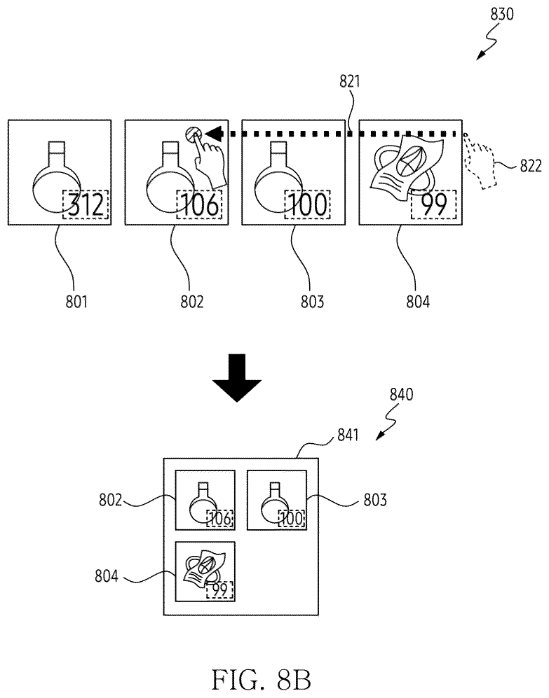

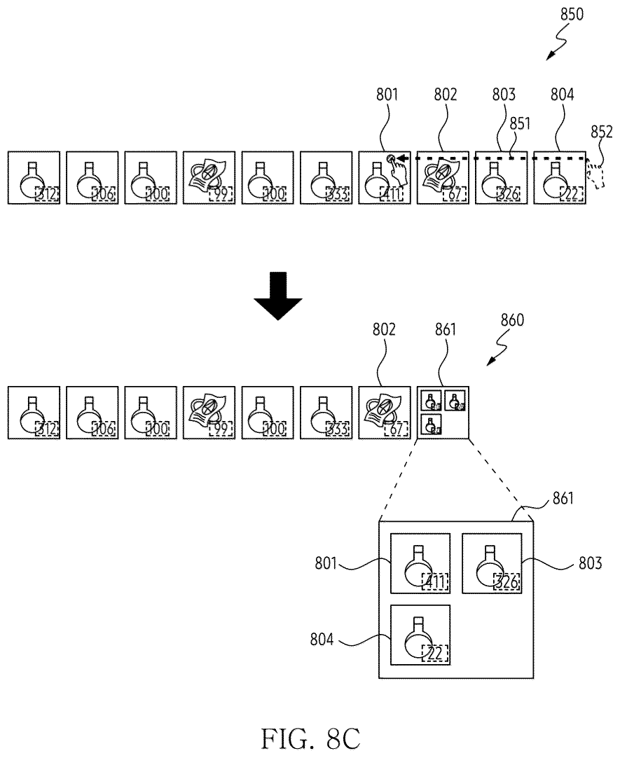

According to one or more embodiments, the electronic device 110 may identify an input for configuring the plurality of slots as one merge slot. An example of the input for configuring the plurality of slots as one merge slot will be described in FIGS. 8A and 8B. The input for configuring the plurality of slots as one merge slot may be an example of the third input.

According to one or more embodiments, the electronic device 110 may identify a setting value related to the number of slots included in the merge slot based on the third input. The electronic device 110 may set the plurality of slots as the merge slot based on the setting value. For example, the number of slots included in the merge slot may be set to 4. The electronic device 110 may set 4 plurality of slots as the merge slot.

For example, the electronic device 110 may execute a plurality of functions related to the plurality of slots based on an input on the merge slot. As an example, the electronic device 110 may use a plurality of items based on an input on the merge slot. As an example, the electronic device 110 may use all or some of the plurality of items based on an input on the merge slot. As an example, the electronic device 110 may cast all or some of a plurality of skills through a PC 202 based on an input on the merge slot. As an example, the electronic device 110 may mount all or some of a plurality of equipment through the PC 202 based on an input on the merge slot.

In operation 520, the electronic device 110 may display a second indicator for setting a second duration for periodic execution of a plurality of functions based on identifying a fourth input on the merge slot.

For example, the operation 520 may correspond to the operation 320. The fourth input may correspond to a first input. The fourth input may mean an input on the merge slot. The first input may mean an input on a single slot, and the fourth input may mean the input on the merge slot. For example, the fourth input may include a long press input, a swipe input, a double tap input, and a double click input. For example, the fourth input may be distinguished from an input for executing a plurality of functions related to the merge slot. As an example, the input for executing the plurality of functions related to the merge slot may include a tap input and a click input.

According to one or more embodiments, the electronic device 110 may display the second indicator for setting the second duration for periodic execution of the plurality of functions related to the merge slot based on identifying the fourth input.

For example, the electronic device 110 may display the second indicator. the electronic device 110 may display the second indicator based on an area expanded from the merge slot. The second indicator may correspond to the first indicator of FIG. 3.

For example, the electronic device 110 may display reference durations together with the second indicator. One of the reference durations may be set to the second duration through the second indicator. According to one or more embodiments, the second indicator may be overlappingly displayed on a slot.

For example, the electronic device 110 may expand and display the plurality of slots included in the merge slot based on the fourth input. The electronic device 110 may expand and display a size of each of the plurality of slots. As an example, the plurality of functions related to the plurality of slots may include a usage function of a plurality of items held by the PC 202. The electronic device 110 may display the number of items to be used during the second duration on each of the plurality of slots based on identifying the fourth input.

For example, the plurality of slots may include a first slot to a fourth slot. The electronic device 110 may display, in the first slot, the number of first items related to the first slot to be used during the second duration based on identifying the fourth input. The electronic device 110 may display, in a second slot, the number of second items related to the second slot to be used during the second duration based on identifying the fourth input. The electronic device 110 may display, in a third slot, the number of third items related to the third slot to be used during the second duration based on identifying the fourth input. The electronic device 110 may display, in the fourth slot, the number of fourth items related to the fourth slot to be used during the second duration based on identifying the fourth input.

As an example, the electronic device 110 may display the number of each of items to be used during the second duration together with the second indicator based on identifying the fourth input. As an example, the electronic device 110 may display the number of each of the items to be used during the second duration, superimposed on the second indicator.

In operation 530, the electronic device 110 may display a second element for representing the second duration, superimposed on the merge slot, based on a fifth input for setting the second duration for periodic execution of the plurality of functions through the second indicator.

According to one or more embodiments, the electronic device 110 may identify the fifth input for setting the second duration for periodic execution of the plurality of functions through the second indicator.

According to one or more embodiments, the electronic device 110 may identify the fifth input for setting the second duration. For example, the electronic device 110 may identify the fifth input for setting the second duration through the second indicator. The fifth input may include a drag input. As an example, the electronic device 110 may change a size of the second indicator based on the drag input. The electronic device 110 may identify the size of the second indicator based on release of the drag input. The electronic device 110 may set the second duration based on the size of the second indicator.

According to one or more embodiments, a period in which each of the plurality of functions is executed may be independently set based on a duration of each of the plurality of items. For example, a duration of the first item may be 10 seconds, and a duration of the second item may be 60 seconds. In a case that the second duration is set to 2 minutes, the electronic device 110 may use the first item 12 times and use the second item twice during the second duration.

According to one or more embodiments, the electronic device 110 may display the second element for representing the second duration superimposed on the merge slot. For example, the electronic device 110 may display the second element for indicating the second duration at an upper left end of the merge slot. The second element may decrease over time. The electronic device 110 may reduce the number of items held by the PC 202 based on periodic execution of a function. In a case that items are used in the second duration, the electronic device 110 may display the number of items held by the PC 202 in the merge slot.

For example, the electronic device 110 may execute the plurality of functions related to the merge slot for a first duration based on satisfaction of a designated condition. As an example, the electronic device 110 may execute the plurality of functions related to the merge slot based on identifying that health of the PC 202 is less than or equal to a designated value for the second duration. The electronic device 110 may use both a health recovery item and a mana recovery item based on identifying that the health of the PC 202 is less than or equal to the designated value. Whenever identifying that the health of the PC 202 is less than or equal to the designated value for the second duration, the electronic device 110 may use both the health recovery item and the mana recovery item.

For example, in a case that the plurality of functions related to the merge slot are set as a plurality of skills that may be performed by the PC 202, the electronic device 110 may simultaneously or sequentially cast the plurality of skills that may be performed by the PC 202 based on periodic execution of a function related to the merge slot.

According to one or more embodiments, the electronic device 110 may periodically execute a plurality of functions related to the merge slot for the second duration without an input on the merge slot. The electronic device 110 may provide a notification to a user after the second duration has elapsed. For example, the electronic device 110 may change a display of the merge slot based on the elapse of the second duration. As an example, the electronic device 110 may display the merge slot to blink based on the elapse of the second duration. As an example, the electronic device 110 may provide a physical vibration based on the elapse of the second duration. As an example, the electronic device 110 may provide a notification indicating that the second duration has elapsed through a visual object representing a pop-up window based on the elapse of the second duration.

FIG. 6 illustrates an example of an operation of configuring slots included in a merge slot according to one or more embodiments.

Referring to FIG. 6, an electronic device 110 may display a UI 201 of a game application through a display 113. For example, the UI 201 may include a designated area 250. The electronic device 110 may display slots within the designated area 250. The electronic device 110 may display a merge slot 610 within the designated area 250.

For example, the merge slot 610 may be configured based on a setting value set by a user. As an example, the number of slots included in the merge slot 610 may be set based on the setting value. The electronic device 110 may identify the setting value related to the number of slots included in the merge slot 610 based on a third input. The electronic device 110 may set a plurality of slots as the merge slot 610.

For example, the merge slot 610 may include a slot 611, a slot 612, a slot 613, and a slot 614. The electronic device 110 may identify an input for setting a function of each of the plurality of slots (i.e., the slot 611, the slot 612, the slot 613, and the slot 614) included in the merge slot 610. The electronic device 110 may display an object 620 for representing the slot 611, the slot 612, the slot 613, and the slot 614 in association with the merge slot 610 based on the input. For example, while the object 620 is displayed, the electronic device 110 may display information on the plurality of slots (i.e., the slot 611, the slot 612, the slot 613, and the slot 614) included in the merge slot 610.

For example, the electronic device 110 may change at least some of a plurality of functions related to the plurality of slots included in the merge slot 610 while the object 620 is displayed. While the object 620 is displayed, the electronic device 110 may display a UI 206. The electronic device 110 may display a list of all functions that may be performed through a PC 202 in the UI 206. The electronic device 110 may assign one of all functions that may be performed through the PC 202 to the slot 611 among the plurality of slots. The electronic device 110 may change a function related to the slot 611 based on assigning one of all functions that may be performed through the PC 202 to the slot 611.

For example, the merge slot 610 may be set based on a function of the same type. The plurality of functions related to the plurality of slots (i.e., the slot 611, the slot 612, the slot 613, and the slot 614) included in the merge slot 610 may be configured with the same type. As an example, all of the plurality of functions related to the plurality of slots may be configured as an item usage function. As an example, all of the plurality of functions related to the plurality of slots may be configured as a skill casting function. As an example, all of the plurality of functions related to the plurality of slots may be configured as an equipment mounting function.

According to one or more embodiments, the merge slot 610 may be configured so that the electronic device 110 executes simultaneously the plurality of functions related to the plurality of slots. The electronic device 110 may simultaneously execute the plurality of functions related to the plurality of slots based on an input on the merge slot 610.

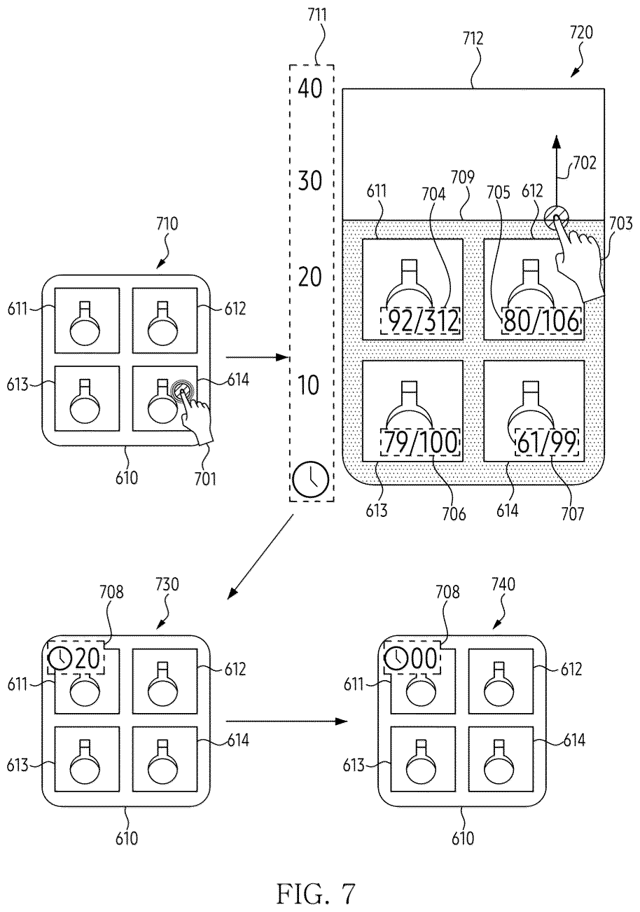

FIG. 7 illustrates an example of an operation of an electronic device for periodic execution of a plurality of functions related to a merge slot according to one or more embodiments.

Referring to FIG. 7, an electronic device 110 may display a UI of a game application through a display 113. For example, the UI may include a designated area 250. The electronic device 110 may display a merge slot 610 within the designated area. The merge slot 610 described in FIG. 7 may correspond to the merge slot 610 of FIG. 6.

In a state 710, the electronic device 110 may display the merge slot 610. For example, the merge slot 610 may be used for execution of a plurality of functions usable for a PC 202. As an example, the merge slot 610 may be used to execute a usage function of a plurality of items. Hereinafter, for convenience of description, an example in which the merge slot 610 is used for execution of the usage function of the plurality of items is described, but is not limited thereto. According to one or more embodiments, the merge slot 610 may be used for casting a plurality of skills. According to one or more embodiments, the merge slot 610 may be used for mounting a plurality of equipment.

According to one or more embodiments, the electronic device 110 may identify an input for executing a plurality of functions (i.e., the usage function of the plurality of items) for the merge slot 610. The input for executing the plurality of functions related to the merge slot 610 may include a tap input and a click input. For example, the electronic device 110 may reduce the number of each of the plurality of items held by the PC 202 based on the input for executing the plurality of functions related to the merge slot 610.

According to one or more embodiments, the electronic device 110 may identify a fourth input 701 on the merge slot 610. For example, the fourth input 701 may include a long press input, a swipe input, a double tap input, and a double click input.

A state 720 may represent a state in which the fourth input 701 is performed. For convenience of description, in the state 720, the fourth input 701 illustrated in the state 410 may be referenced.

In the state 720, the electronic device 110 may display a second indicator 709 for setting a second duration for periodic execution of the plurality of functions related to the merge slot 610, based on identifying the fourth input 701. For example, the electronic device 110 may display the second indicator 709 superimposed on the merge slot 610.

According to one or more embodiments, the electronic device 110 may expand the merge slot 610. The electronic device 110 may display the second indicator 709 based on expanding the merge slot 610. For example, the electronic device 110 may expand a shape of the merge slot 610 based on identifying the fourth input 701. For example, the electronic device 110 may set an area 712 in which the second indicator 709 is movable based on expanding the merge slot 610. The electronic device 110 may set the second indicator 709 to be movable within the area 712.

For example, the electronic device 110 may move the second indicator 709 along one of a direction 702 and a direction opposite to the direction 702. As the second indicator 709 is moved in the direction 702, a size of the second indicator 709 may increase. As the second indicator 709 is moved in the direction opposite to the direction 702, the size of the second indicator 709 may decrease.

For example, the electronic device 110 may display reference durations together with the second indicator 709. The electronic device 110 may display an element 711 for displaying the reference durations together with the merge slot 610. According to one or more embodiments, the element 711 may be disposed to be adjacent to the merge slot 610 along the direction 702.

For example, the electronic device 110 may set one of the reference durations as the second duration through the second indicator 709. As an example, the electronic device 110 may set the second duration to be shorter based on the decrease in the size of the second indicator 709. The electronic device 110 may set the second duration to be longer based on the increase in the size of the second indicator 709.

For example, the electronic device 110 may identify a fifth input 703 for setting the second duration. The electronic device 110 may identify the fifth input 703 for moving the second indicator 709 and for releasing the movement of the second indicator 709. As an example, the fifth input 703 may include a drag input. The electronic device 110 may move the second indicator 709 based on the drag input which is the fifth input 703. The electronic device 110 may set one of the reference durations indicated by the second indicator 709 as the second duration based on release of the drag input.

For example, the electronic device 110 may display element 704, element 705, element 706, and element 707 representing the number of a plurality of items to be used during the second duration together with the second indicator 709. As an example, the electronic device 110 may display the element 704 representing the number of first items related to a slot 611 to be used during the second duration in the slot 611. As an example, the electronic device 110 may display the element 705 representing the number of second items related to a slot 612 to be used during the second duration in the slot 612. As an example, the electronic device 110 may display the element 706 representing the number of third items related to a slot 613 to be used during the second duration in the slot 613. As an example, the electronic device 110 may display the element 707 representing the number of fourth items related to a slot 614 to be used during the second duration in the slot 614.

According to one or more embodiments, each of the element 704, the element 705, the element 706, and the element 707may represent the number of items to be used during the second duration for the number of items held by the PC 202. For example, the element 704 may represent the number of first items (e.g., ‘92’ in the slot 611) to be used during the second duration for the number of first items held by the PC 202 (e.g., ‘312’ in the slot 611). The element 705 may represent the number of second items (e.g., ‘80’ in the slot 612) to be used during the second duration for the number of second items held by the PC 202 (e.g., ‘106’ in the slot 612). The element 706 may represent the number of third items (e.g., ‘79’ in the slot 613) to be used during the second duration for the number of third items held by the PC 202 (e.g., ‘100’ in the slot 613). The element 707 may represent the number of fourth items (e.g., ‘61’ in the slot 614) to be used during the second duration for the number of fourth items held by the PC 202 (e.g., ‘99’ in the slot 614).

In a state 730, based on the fifth input, the electronic device 110 may display a second element 708 for representing the second duration, superimposed on the merge slot 610. For example, the electronic device 110 may identify the fifth input. The electronic device 110 may identify the second duration based on the fifth input. The electronic device 110 may display the second element 708 for representing the second duration, superimposed on the merge slot 610.

For example, the electronic device 110 may display the second element 708 for representing the second duration on an upper left end of the merge slot 610. The second element 708 may decrease over time. For example, the electronic device 110 may reduce the number of each of the plurality of items held by the PC 202 based on the periodic execution of the plurality of functions.

A duration of each of the plurality of items may be set differently from each other. Each of the plurality of functions may be performed independently in the second duration. A period in which each of the plurality of functions is executed may be independently set based on the duration of each of the plurality of items. For example, a duration of the first item related to the slot 611 may be set to 10 seconds. A duration of the second item related to the slot 612 may be set to 20 seconds. A duration of the third item related to the slot 613 may be set to 30 seconds. A duration of the fourth item related to the slot 614 may be set to 60 seconds. In a case that the second duration is set to 2 minutes, the electronic device 110 may use the first item at a period of 10 seconds in the second duration. The electronic device 110 may use the second item at a period of 20 seconds in the second duration. The electronic device 110 may use the third item at a period of 30 seconds in the second duration. The electronic device 110 may use the fourth item at a period of 60 seconds in the second duration.

In a state 740, the electronic device 110 may periodically execute the plurality of functions related to the merge slot 610 for the second duration without an input on the merge slot 610. The electronic device 110 may provide a notification to a user after the second duration has elapsed. For example, the electronic device 110 may change a display of the merge slot 610 based on the elapse of the second duration. As an example, the electronic device 110 may display the merge slot 610 to blink based on the elapse of the second duration. As an example, the electronic device 110 may provide a physical vibration based on the elapse of the second duration. As an example, the electronic device 110 may provide a notification representing that the second duration has elapsed through a visual object representing a pop-up window based on the elapse of the second duration.

For example, based on the elapse of the second duration, the second element 708 may be changed to represent that the second duration has elapsed.

FIG. 8A illustrates an example of an operation of an electronic device for configuring a merge slot according to one or more embodiments.

FIG. 8B illustrates an example of an operation of an electronic device for configuring a merge slot according to one or more embodiments.

FIG. 8C illustrates an example of an operation of an electronic device for configuring a merge slot according to one or more embodiments.

Referring to FIG. 8A, in a state 810, an electronic device 110 may display a UI (e.g., the UI 201 of FIG. 2) of a game application through a display 113. For example, the UI 201 may include a designated area (e.g., the designated area 250 of FIG. 2). The electronic device 110 may display slots within the designated area. For example, in the electronic device 110, the slots within the designated area may include a slot 801, a slot 802, a slot 803, and a slot 804. The slot 801, the slot 802, the slot 803, and the slot 804 described in FIG. 7 may be an example of slots included in the designated area 250 of FIG. 2.

According to one or more embodiments, the slot 801, the slot 802, the slot 803, and the slot 804 may be disposed in a row. The electronic device 110 may identify a drag input 812 on an area corresponding to the slot 801, the slot 802, the slot 803, and the slot 804, in a state in which the slot 801, the slot 802, the slot 803, and the slot 804 are disposed in a row. The electronic device 110 may identify the drag input 812 that moves along a direction 811.

According to one or more embodiments, the electronic device 110 may change a state of the electronic device 110 from the state 810 to a state 820 based on the drag input 812.

The state 820 may represent a state in which the drag input 812 is released. For convenience of description, in the state 820, the drag input 812 of the state 810 may be referenced.

In the state 820, the electronic device 110 may configure a merge slot 800 including the slot 801, the slot 802, the slot 803, and the slot 804. The electronic device 110 may identify slots on a path of the drag input 812 based on the drag input 812. The electronic device 110 may identify the slot 801, the slot 802, the slot 803, and the slot 804 on the path of the drag input 812. The electronic device 110 may configure the slot 801, the slot 802, the slot 803, and the slot 804, which are the slots on the path of the drag input 812, as the merge slot 800.

Referring to FIG. 8B, in a state 830, the electronic device 110 may display the slots within the designated area 250. For example, in the electronic device 110, the slots within the designated area 250 may include the slot 801, the slot 802, the slot 803, and the slot 804.

According to one or more embodiments, the slot 801, the slot 802, the slot 803, and the slot 804 may be disposed in a row. The electronic device 110 may identify a drag input 822 on the area corresponding to the slot 802, the slot 803, and the slot 804, in a state in which the slot 801, the slot 802, the slot 803, and the slot 804 are disposed in a row. The electronic device 110 may identify the drag input 822 that moves along a direction 821.

According to one or more embodiments, the electronic device 110 may change a state of the electronic device 110 from the state 830 to a state 840 based on the drag input 822.

The state 840 may represent a state in which the drag input 822 is released. For convenience of description, in the state 840, the drag input 822 of the state 830 may be referenced.

In the state 840, the electronic device 110 may configure a merge slot 841 including the slot 802, the slot 803, and the slot 804. The electronic device 110 may identify slots on a path of the drag input 822 based on the drag input 822. The electronic device 110 may identify the slot 802, the slot 803, and the slot 804 on the path of the drag input 822. The electronic device 110 may configure the slot 802, the slot 803, and the slot 804, which are the slots on the path of the drag input 822, as the merge slot 841.

Referring to FIGS. 8A and 8B, the electronic device 110 may identify slots on the path of the drag input. The electronic device 110 may configure the slots on the path of the drag input as one merge slot. The electronic device 110 may identify the number of slots on the path of the drag input. The electronic device 110 may configure a merge slot based on the number of slots on the path of the drag input. In a case that the number of slots on the path of the drag input exceeds the maximum allowable number, the electronic device 110 may configure the maximum allowable number of slots among the slots on the path of the drag input as a merge slot.

Referring to FIG. 8C, in a state 850, the electronic device 110 may display the slots within the designated area 250. For example, in the electronic device 110, the slots within the designated area 250 may include the slot 801, the slot 802, the slot 803, and the slot 804.

Types of functions assigned to each of the slot 801, the slot 802, the slot 803, and the slot 804 may be different. For example, a function related to the slot 801 may be an item usage function. A function related to slot 802 may be a skill casting function. A function related to the slot 803 may be an item usage function. A function related to the slot 804 may be an item usage function.

According to one or more embodiments, the electronic device 110 may identify a drag input 852 in a direction 851. The electronic device 110 may identify slots on a path of the drag input 852. The electronic device 110 may configure a merge slot based on a function of the same type. For example, the electronic device 110 may identify that the functions of the slot 801, the slot 802, the slot 803, and the slot 804 include the item usage function and the skill casting function. The electronic device 110 may identify that the number of slots to which the item usage function is assigned is greater than the number of slots to which the skill casting function is assigned. As an example, the electronic device 110 may identify that the number of slots to which the item usage function is assigned is 3. The electronic device 110 may identify that the number of slots to which the skill casting function is assigned is 1.

In a state 860, the electronic device 110 may configure slots to which the item usage function is assigned as a merge slot 861 based on identifying that the number of slots to which the item usage function is assigned is greater than the number of slots to which the skill casting function is assigned. The electronic device 110 may configure the slot 801, the slot 803, and the slot 804 as the one merge slot 861. The electronic device 110 may not configure the slot 802 as the merge slot 861, but may configure the slot 801, the slot 803, and the slot 804 as the merge slot 861. The electronic device 110 may configure the merge slot 861 based on a function of the same type (e.g., an item type).

In the above-described embodiment, an example of configuring a merge slot (e.g., the merge slot 861) based on a function of the same type has been described, but is not limited thereto. For example, the electronic device 110 may configure a merge slot based on a setting value set by a user. For example, the electronic device 110 may configure a merge slot based on functions frequently used by other users in a virtual space in a game.

According to one or more embodiments, an electronic device may include a display, memory storing instructions, and at least one processor operably coupled to the display and the memory, and the at least one processor may configured to, when executing the instructions, display a slot for executing a function usable for a player character (PC) within a designated area of the display, display a first indicator for setting a first duration for periodic execution of a function related to the slot based on identifying a first input on the slot, and display a first element for representing the first duration, superimposed on the slot, based on a second input for setting the first duration for the periodic execution of the function through the first indicator.

According to one or more embodiments, the function may include a usage function of items held by the PC, and the at least one processor may be further configured to, when executing the instructions, reduce, based on the periodic execution of the function, the number of the items held by the PC.

According to one or more embodiments, the at least one processor may be further configured to, when executing the instructions, based on a duration of the items, periodically execute the function for the first duration.

According to one or more embodiments, the at least one processor may be further configured to, when executing the instructions, display, within the slot, overlappingly the number of items held by the PC, and based on identifying the first input, display the number of the items to be used during the first duration together with the first indicator.

According to one or more embodiments, the at least one processor may be further configured to, when executing the instructions, based on the periodic execution of the function, cast a skill which may be performed by the PC.

According to one or more embodiments, the at least one processor may be further configured to, when executing the instructions, identify a third input for setting a merge slot including a plurality of slots, wherein the plurality of slots include the slot, display a second indicator for setting a second duration for periodic execution of a plurality of functions related to the plurality of slots based on identifying a fourth input on the merge slot, and display a second element for representing the second duration, superimposed on the merge slot, based on a fifth input for setting the second duration for periodic execution of the plurality of functions through the second indicator.

According to one or more embodiments, the plurality of functions may include a usage function of a plurality of items related to the plurality of slots, and a period in which each of the plurality of functions is executed, may be set independently based on a duration of each of the plurality of items.

According to one or more embodiments, the at least one processor may be further configured to, when executing the instructions, based on a sixth input on the merge slot, display a visual object for changing the plurality of functions related to the plurality of slots included in the merge slot.

According to one or more embodiments, the at least one processor may be further configured to, when executing the instructions, based on the third input, identify a setting value related to the number of slots included in the merge slot, and set, based on the setting value, the plurality of slots as the merge slot.

According to one or more embodiments, the merge slot may be configured based on the same type of function.

According to one or more embodiments, a method of an electronic device may include displaying a slot for executing a function usable for a player character (PC) within a designated area of the display, displaying a first indicator for setting a first duration for periodic execution of a function related to the slot based on identifying a first input on the slot, and displaying a first element for representing the first duration, superimposed on the slot, based on a second input for setting the first duration for the periodic execution of the function related to the slot through the first indicator.

According to one or more embodiments, the function may include a usage function of items held by the PC, and the method may further include reducing, based on the periodic execution of the function, the number of the items held by the PC.

According to one or more embodiments, the method may further include based on a duration of the items, periodically executing the function for the first duration.

According to one or more embodiments, the method may further include displaying, within the slot, overlappingly the number of items held by the PC, and based on identifying the first input, displaying the number of the items to be used during the first duration together with the first indicator.

According to one or more embodiments, the method may further include, based on the periodic execution of the function, casting a skill which may be performed by the PC.

According to one or more embodiments, the method may further include identifying a third input for setting a merge slot including a plurality of slots, wherein the plurality of slots include the slot, displaying a second indicator for setting a second duration for periodic execution of a plurality of functions related to the plurality of slots based on identifying a fourth input on the merge slot, and displaying a second element for representing the second duration, superimposed on the merge slot based on a fifth input for setting the second duration for periodic execution of the plurality of functions through the second indicator.

According to one or more embodiments, the plurality of functions may include a usage function of a plurality of items related to the plurality of slots, and a period in which each of the plurality of functions is executed, may be set independently based on a duration of each of the plurality of items.

According to one or more embodiments, the method may further include, based on a sixth input on the merge slot, displaying a visual object for changing the plurality of functions related to the plurality of slots included in the merge slot.

According to one or more embodiments, the method may further include, based on the third input, identifying a setting value related to the number of slots included in the merge slot, and setting, based on the setting value, the plurality of slots as the merge slot.

According to one or more embodiments, a computer readable storage media may store one or more programs. The one or more programs may include instructions which, when executed by at least one processor of an electronic device with a display, cause the electronic device to display a slot for executing a function usable for a player character (PC) within a designated area of the display, display a first indicator for setting a first duration for periodic execution of a function related to the slot based on identifying a first input on the slot, and display a first element for representing the first duration, superimposed on the slot based on a second input for setting the first duration for the periodic execution of the function through the first indicator.

Methods according to embodiments described in claims or specifications of the present disclosure may be implemented as a form of hardware, software, or a combination of hardware and software.

In a case of implementing as software, a computer-readable storage medium for storing one or more programs (software module) may be provided. The one or more programs stored in the computer-readable storage medium are configured for execution by one or more processors in an electronic device. The one or more programs include instructions that cause the electronic device to execute the methods according to embodiments described in claims or specifications of the present disclosure.

Such a program (software module, software) may be stored in a random access memory, a non-volatile memory including a flash memory, a ROM, an EEPROM, a magnetic disc storage device, an optical storage device (e.g., a CD-ROM, digital versatile discs (DVDs), or other formats), a magnetic cassette or memory configured with a combination thereof. Alternatively, it may be stored in memory configured with a combination of some or all of them. In addition, a plurality of configuration memories may be included. Additionally, a program may be stored in an attachable storage device that may be accessed through a communication network such as the Internet, Intranet, LAN, WAN, or storage area network (SAN), or a combination thereof. Such a storage device may be connected to a device performing one or more embodiments of the present disclosure through an external port. In addition, a separate storage device on the communication network may also be connected to a device performing one or more embodiments of the present disclosure.

In the above-described specific embodiments of the present disclosure, components of the electronic device included in the disclosure are expressed in the singular or plural according to the presented specific embodiment. However, the singular or plural expression for the components is selected appropriately according to a situation presented for convenience of explanation, and the present disclosure is not limited to the singular or plural component, and even components expressed in the plural may be configured in the singular, or a component expressed in the singular may be configured in the plural.

Meanwhile, specific embodiments have been described in the detailed description of the present disclosure, and of course, various modifications are possible without departing from the scope of the present disclosure. Therefore, the scope of the present disclosure should not be limited to the described embodiments, but should be defined not only by the scope of the claims described below but also by equivalents of the claims.

What is claimed is:

1. An electronic device comprising:
a display;
memory storing instructions; and
at least one processor operably coupled to the display and the memory,
wherein the at least one processor is configured to, when executing the instructions:
display a slot representing a function of a player character (PC) displayed within a designated area of the display;
based on identifying a first input indicating the slot, display a first indicator configured to adjustably set a first duration of a periodic execution of at least the function represented by the slot; and
based on identifying a second input indicating to set the first duration of the periodic execution of at least the function through the first indicator, display a first element, representing the first duration, superimposed on the slot.

2. The electronic device of claim 1, wherein the function comprises a usage function of at least one item of one or more items held by the PC, and
wherein the at least one processor is further configured to, when executing the instructions:
reduce, based on the periodic execution of at least the function represented by the slot, a number of the at least one item of the one or more items held by the PC.

3. The electronic device of claim 1, wherein the at least one processor is further configured to, when executing the instructions:
based on a duration of at least one item of one or more items represented by the slot, periodically execute at least the function represented by the slot and for the first duration.

4. The electronic device of claim 1, wherein the at least one processor is further configured to, when executing the instructions:
display, overlapping within the slot, a number of at least one item of one or more items held by the PC; and
based on identifying the first input, further display the number of the at least one item of the one or more items, as identified as to be used together during the first duration, together with the first indicator.

5. The electronic device of claim 1, wherein the at least one processor is further configured to, when executing the instructions:
based on the periodic execution of at least the function, cast a skill, as performed by the PC, as the function represented by the slot.

6. The electronic device of claim 1, wherein the at least one processor is further configured to, when executing the instructions:
identify a third input indicating to set a merge slot including a plurality of slots representing a plurality of functions,
wherein the plurality of slots includes the slot, and
wherein the plurality of functions includes the function.

7. The electronic device of claim 6, wherein the plurality of functions comprises a usage function of a plurality of items represented by the plurality of slots, and
wherein periods, in which each of the plurality of functions are executed respectively, are set independently based on durations of each of the plurality of items represented by the plurality of slots.

8. The electronic device of claim 6, wherein the at least one processor is further configured to, when executing the instructions:
based on a sixth input on the merge slot, display a visual object configured to change one or more of the plurality of slots, representing the plurality of functions, included in the merge slot.

9. The electronic device of claim 6, wherein the at least one processor is further configured to, when executing the instructions:
based on the third input, identify a setting value representing a number of slots to be included in the merge slot, the number of slots being a number of the plurality of slots; and
set, based on the setting value, the plurality of slots as the merge slot.

10. The electronic device of claim 6, wherein the merge slot is configured to merge the plurality of slots to the merge slot based on the plurality of functions represented by the plurality of slots being identified as of a same type of function.

11. A method of an electronic device, the method comprising:
displaying a slot representing a function of a player character (PC) displayed within a designated area of the display;
based on identifying a first input indicating the slot, displaying a first indicator configured to adjustably set a first duration of a periodic execution of at least the function represented by the slot; and
based on identifying a second input indicating to set the first duration of the periodic execution of at least the function related to the slot through the first indicator, displaying a first element, representing the first duration, superimposed on the slot.

12. The method of claim 11, wherein the function comprises a usage function of at least one item of one or more items held by the PC, and
wherein the method further comprises:
reducing, based on the periodic execution of at least the function represented by the slot, a number of the at least one item of the one or more items held by the PC.

13. The method of claim 11, wherein the method further comprises:
based on a duration of at least one item of one or more items represented by the slot, periodically executing at least the function represented by the slot and for the first duration.

14. The method of claim 11, wherein the method further comprises:
displaying, overlapping within the slot, a number of at least one item of one or more items held by the PC; and
based on identifying the first input, further displaying the number of the at least one item of the one or more items, as identified as to be used together during the first duration, together with the first indicator.

15. The method of claim 11, wherein the method further comprises:
based on the periodic execution of at least the function, casting a skill, as performed by the PC, as the function represented by the slot.

16. The method of claim 11, wherein the method further comprises:
identifying a third input indicating to set a merge slot including a plurality of slots representing a plurality of functions, wherein the plurality of slots includes the slot; and wherein the plurality of functions includes the function;
based on identifying a fourth input as indicating the merge slot, displaying a second indicator configured to set a second duration for a second periodic execution of the plurality of functions represented by the plurality of slots; and
based on a fifth input indicating, through the second indicator, to set the second duration for the second periodic execution of the plurality of functions, displaying a second element, representing the second duration, superimposed on the merge slot.

17. The method of claim 16, wherein the plurality of functions comprises a usage function of a plurality of items represented by the plurality of slots, and
wherein periods, in which each of the plurality of functions are executed respectively, are set independently based on durations of each of the plurality of items represented by the plurality of slots.

18. The method of claim 16, wherein the method further comprises:
based on a sixth input on the merge slot, displaying a visual object configured to change one or more of the plurality of slots, representing the plurality of functions, included in the merge slot.

19. The method of claim 16, wherein the method further comprises:
based on the third input, identifying a setting value representing a number of slots to be included in the merge slot, the number of slots being a number of the plurality of slots; and
setting, based on the setting value, the plurality of slots as the merge slot.

20. A computer readable storage media storing one or more programs, wherein the one or more programs include instructions which, when executed by at least one processor of an electronic device with a display, cause the electronic device to:
display a slot representing a function of a player character (PC) displayed within a designated area of the display;
based on identifying a first input indicating the slot, display a first indicator for setting a first duration for periodic execution of a function related to the slot; and
based on identifying a second input setting the first duration of the periodic execution of at least the function related to the slot through the first indicator, display a first element, representing the first duration, superimposed on the slot.
